(19) United States
(12) Patent Application Publication
(10) Pub. No.: US 2025/0021874 A1
(43) Pub. Date: Jan. 16, 2025

(54) OUTLIER REMOVAL METHOD AND OUTLIER REMOVAL DEVICE

(71) Applicant: Proterial, Ltd., Tokyo (JP)

(72) Inventors: Tomonori WATANABE, Tokyo (JP); Daisuke SHANAI, Tokyo (JP); Takehiko TANI, Tokyo (JP)

(21) Appl. No.: 18/742,534

(22) Filed: Jun. 13, 2024

(30) Foreign Application Priority Data
Jul. 14, 2023 (JP) 2023-115886

(51) Int. Cl. G06N 20/00

(52) U.S. Cl. CPC G06N 20/00

(57) ABSTRACT

An outlier removal method for removing an outlier included in training data that has data of an explanatory variable and an objective variable used for machine learning. The method includes calculating prediction errors by repeating, a predetermined number of times, division of the training data into teaching data and test data, creation of a regression model representing a correlation between the explanatory variable and the objective variable using the teaching data, and calculation of a prediction error using the test data on the created regression model, calculating a distribution by extracting, for each data included in the training data, prediction errors when using that data as the test data from prediction errors obtained in the calculating prediction errors, and obtaining, for each data included in the training data, an index value characterizing a distribution of the extracted prediction errors, determining an outlier by determining whether each data is an outlier based on the index value of each data obtained in the calculating a distribution, and removing an outlier by removing data determined to be an outlier in the determining an outlier.

### CROSS-REFERENCE TO RELATED APPLICATIONS

The present patent application claims the priority of Japanese patent application No. 2023-115886 filed on Jul. 14, 2023, the entire contents of which are incorporated herein by reference.

### TECHNICAL FIELD

The present invention relates to an outlier removal method and an outlier removal device.

### BACKGROUND OF THE INVENTION

Methods for making various predictions using machine learning are known. For example, in case of predicting the physical properties of a material with unknown mixing proportion, machine learning is performed using data already obtained through trial manufacturing, etc., as training data (teaching data, supervised data) to learn the correlation between the mixing proportions of the materials and the physical properties, and prediction is made using a regression model obtained as a result of the learning.

Prior art document information related to the invention of the present application includes Patent Literature 1.
Citation List Patent Literature 1: JP2020-123365A

### SUMMARY OF THE INVENTION

However, if training data contains erroneous data or outliers, which are data with large errors, the prediction accuracy of the regression model obtained using such training data decreases. Therefore, it is desirable to remove outliers from the training data prior to machine learning. However, it is difficult to determine which data are outliers properly. Particularly when the training data is sparse data, it is difficult to remove outliers properly.

Therefore, the object of the invention is to provide an outlier removal method and an outlier removal device that can properly remove outliers.

To solve the problems described above, one aspect of the present invention provides an outlier removal method for removing an outlier included in training data that comprises data of an explanatory variable and an objective variable used for machine learning, the method comprising:
calculating prediction errors by repeating, a predetermined number of times, division of the training data into teaching data and test data, creation of a regression model representing a correlation between the explanatory variable and the objective variable using the teaching data, and calculation of a prediction error using the test data on the created regression model;
calculating a distribution by extracting, for each data included in the training data, prediction errors when using that data as the test data from prediction errors obtained in the calculating prediction errors, and obtaining, for each data included in the training data, an index value characterizing a distribution of the extracted prediction errors; determining an outlier by determining whether each data is an outlier based on the index value of each data obtained in the calculating a distribution; and
removing an outlier by removing data determined to be an outlier in the determining an outlier.

To solve the problems described above, another aspect of the present invention provides an outlier removal device that removes an outlier included in training data that comprises data of an explanatory variable and an objective variable used for machine learning, the device comprising:
a prediction error calculation processing unit that repeats, a predetermined number of times, division of the training data into teaching data and test data, creation of a regression model representing a correlation between the explanatory variable and the objective variable using the teaching data, and calculation of a prediction error using the test data on the created regression model;
a distribution calculation processing unit that extracts, for each data included in the training data, prediction errors when using that data as the test data from prediction errors obtained by the prediction error calculation processing unit, and obtains, for each data included in the training data, an index value characterizing a distribution of the extracted prediction errors;
an outlier determination processing unit that determines whether each data is an outlier based on the index value of each data obtained by the distribution calculation processing unit; and
an outlier removal processing unit that removes data determined to be an outlier by the outlier determination processing unit.

### Advantageous Effects of the Invention

According to the invention, it is possible to provide an outlier removal method and an outlier removal device that can properly remove outliers.

### BRIEF DESCRIPTION OF DRAWINGS

FIG. 1 is a schematic configuration diagram illustrating an outlier removal device in an embodiment of the present invention.

FIG. 2 is a diagram illustrating an example of training data.

FIG. 3A is an explanatory diagram illustrating prediction error calculation processing.

FIG. 3B is an explanatory diagram illustrating distribution calculation processing.

FIG. 4 is a diagram explaining the reason why both MAE and MAPE are used as index values.

FIG. 5 is a diagram illustrating an example of distributions of medians of MAE and MAPE obtained by the distribution calculation processing.

FIG. 6 is a flowchart showing an outlier removal method in the embodiment of the invention.

FIG. 7 is a flowchart showing the prediction error calculation processing.

FIG. 8 is a flowchart showing the distribution calculation processing.

FIG. 9 is a flowchart showing outlier determination processing.

FIG. 10 is a flowchart showing outlier removal processing.

FIG. 11A is a diagram illustrating changes in coefficient of determination when outlier removal is performed.

FIG. 11B is a diagram illustrating changes in MAE when the outlier removal is performed.

FIG. 11C is a diagram illustrating changes in MAPE when the outlier removal is performed.

### DETAILED DESCRIPTION OF THE INVENTION

### Embodiment

An embodiment of the invention will be described below in conjunction with the appended drawings.

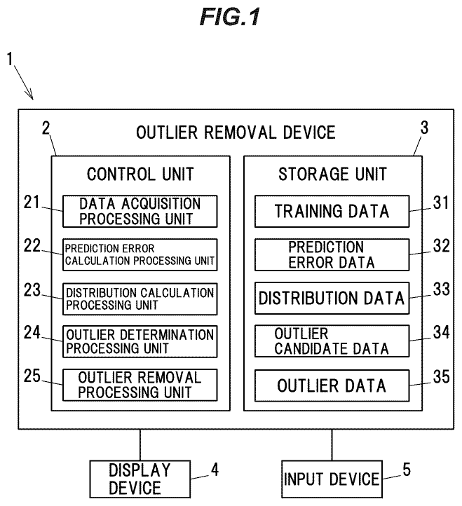

FIG. 1 is a schematic configuration diagram illustrating an outlier removal device 1 in the present embodiment. The outlier removal device 1 is a device that removes outliers included in training data 31 which is used for machine learning. The outlier means a value that deviates significantly from other data due to, e.g., a measurement error, human error such as misreading the instrument or input mistake, or influence of noise, etc. Detecting and removing outliers from the training data 31 is expected to improve prediction accuracy when machine learning is performed using the training data 31.

The outlier removal device 1 has a control unit 2 and a storage unit 3. The outlier removal device 1 is, e.g., a computer such as personal computer or server device, and includes an arithmetic element such as a CPU, a memory such as RAM or ROM, a storage device such as hard disk, and a communication interface that is a communication device such as LAN card.

The control unit 2 has a data acquisition processing unit 21, a prediction error calculation processing unit 22, a distribution calculation processing unit 23, an outlier determination processing unit 24 and an outlier removal processing unit 25. Details of each unit will be described later. The storage unit 3 is realized by a predetermined storage area of a memory or storage device.

The outlier removal device 1 also has a display device 4 and an input device 5. The display device 4 is, e.g., a liquid crystal display, and the input device 5 is, e.g., a keyboard and a mouse, etc. The display device 4 may be configured as a touch panel, and the display device 4 may also serve as the input device 5. In addition, the display device 4 and the input device 5 may be configured separately from the outlier removal device 1 and be capable of communicating with the outlier removal device 1 by wireless communication, etc. In this case, the display device 4 or input device 5 may be composed of a portable terminal such as a tablet or smartphone.

### Data Acquisition Processing Unit 21

The data acquisition processing unit 21 performs data acquisition processing to acquire the training data 31 from an external device. In the data acquisition processing, for example, the training data 31 is acquired through a network from a prediction device, etc. which uses the training data 31. However, the training data 31 may be, e.g., input to the outlier removal device 1 via a medium such as USB memory, and the method for acquiring the training data 31 is not particularly limited.

### Training Data 31

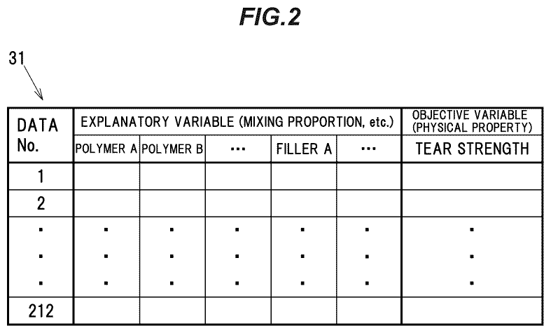

Here, the training data 31 will be described. FIG. 2 is a diagram illustrating an example of the training data 31. The training data 31 is a database used as teaching data when performing machine learning, and includes data of explanatory and objective variables used in machine learning. FIG. 2 shows an example in which the mixing amounts of materials such as polymers and fillers, etc., are used as explanatory variables, and the physical property (tear strength in this example) of a composite material produced using said materials is used as an objective variable. Performing machine learning using this training data 31 and creating a regression model representing a correlation between the explanatory variable (the mixing amount of each material) and the objective variable (the physical property) allows for prediction of the physical property of a composite material when manufactured with unknown mixing proportions of materials.

### Prediction Error Calculation Processing Unit 22

The prediction error calculation processing unit 22 performs prediction error calculation processing in which division of the training data 31 into teaching data and test data, creation of a regression model (a trained model) representing a correlation between the explanatory variable and the objective variable using the teaching data, and calculation of a prediction error using the test data on the created regression model are repeated a predetermined number of times. The prediction error calculation processing corresponds to the calculating prediction errors in the invention.

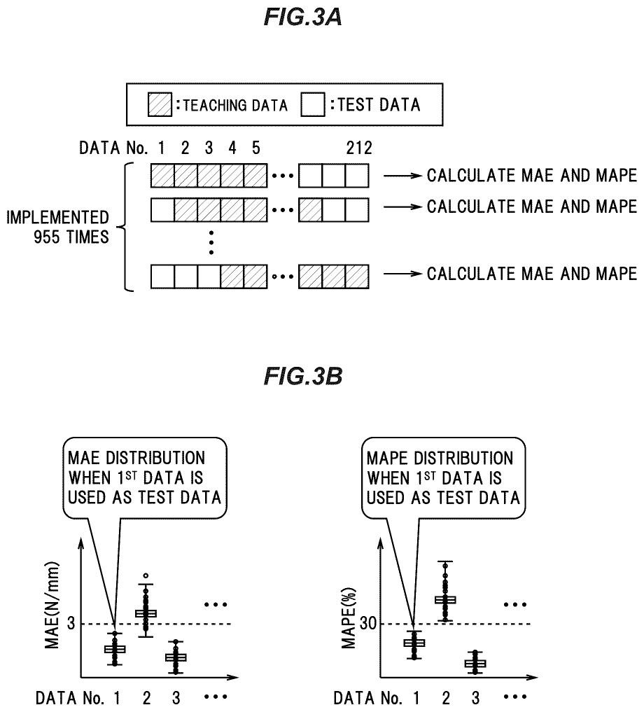

As shown in FIG. 3A, first, the prediction error calculation processing unit 22 randomly divides the training data 31 into teaching data and test data. The ratio of the teaching data to the test data may be set in advance, and can be set to, e.g., 70% for the teaching data and 30% for the test data. After data division, machine learning is performed using the teaching data, and as a result of this machine learning, a regression model representing the correlation between the explanatory variable and the objective variable is created. Then, by applying the test data to the created regression model, a predicted value of the objective variable is obtained and also a prediction error representing an error between the predicted value and the measured value (a value of the objective variable in the test data) is obtained.

Mean error (ME), mean absolute error (MAE), root mean square error (RMSE), mean percentage error (MPE), mean absolute percentage error (MAPE) and root mean square percentage error (RMSPE), etc. can be used as the prediction error. More preferably, at least one of ME, MAE and RMSE and one of MPE, MAPE and RMSPE may be used as the prediction error. In the present embodiment, MAE and MAPE are used as prediction errors.

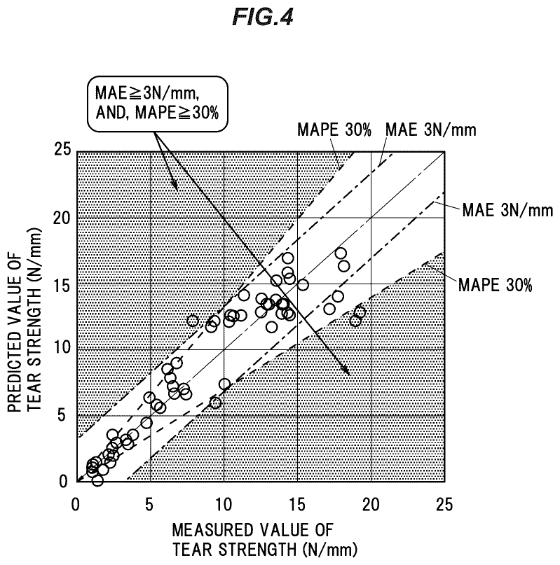

FIG. 4 shows an example of a relationship between the predicted value and the measured value when test data is applied to a regression model created using teaching data. As shown in FIG. 4, in case that only MAE (or ME, or RMSE) is used, determination is easy when the value of the objective variable (tear strength in this example) is small, but when the value of the objective variable (tear strength in this example) is large, determination is difficult and data which is not an outlier may be determined to be an outlier. On the other hand, in case that only MAPE (or MPE, or RMSPE) is used, determination is easy when the value of the objective variable (tear strength in this example) is large, but when the value of the objective variable (tear strength in this example) is small, determination is difficult and data which is not an outlier may be determined to be an outlier. Therefore, in the present embodiment, both MAE (or ME, or RMSE) and MAPE (or MPE, or RMSPE) are used as the prediction errors. The obtained prediction errors are stored as prediction error data 32 in the storage unit 3.

The prediction error calculation processing unit 22 repeats, a preset number of times, the division of the training data 31, the creation of the regression model using the teaching data, and the calculation of the prediction error by applying the test data to the regression model. The number of repetitions may be appropriately determined according to the number of data included in the training data 31, and may be appropriately determined so that about several tens to several hundreds (desirably not less 100) of prediction errors (MAEs and MAPEs in this example) are obtained when given data is used as the test data. In this example, considering that the number of data is 212, the number of repetitions is set to 955. As a result, about 300 prediction errors were obtained for each data when that data was used as test data.

### Distribution Calculation Processing Unit 23

The distribution calculation processing unit 23 performs distribution calculation processing to extract, for each data included in the training data 31, prediction errors when using that data as the test data from prediction errors (MAEs and MAPEs) obtained in the prediction error calculation processing, and obtain, for each data included in the training data 31, an index value characterizing a distribution of the extracted prediction errors. The distribution calculation processing corresponds to the calculating a distribution in the invention.

In the distribution calculation processing, as shown in FIG. 3B, MAEs and MAPEs when, e.g., the 1^{st} data (No. 1) is used as test data are extracted from the prediction error data 32 to respectively obtain a distribution of MAE and a distribution of MAPE, and the index values characterizing the distributions are calculated. In the present embodiment, a median value of the distribution is used as the index value. This is because when using the median value as the index value, the number of data that are more than the index value in the error distribution is always not less than half (50%), and it is easy to judge how much the data determined to be outliers are greater than the index value. However, it is not limited thereto, and, e.g., an average value, etc. may be used.

In the distribution calculation process, a percentage of errors of not less than a preset determination criterion value in the prediction error distribution is determined. In more detail, a percentage of MAE (or ME, or RMSE) of not less than a preset first determination criterion value (3 N/mm in FIG. 3B) and a percentage of MAPE (or MPE, or RMSPE) of not less than a preset second determination criterion value (30% in FIG. 3B) are respectively determined, and an average value of these percentages (hereinafter, referred to as the “rate of criterion exceedance”) is then obtained. For example, when 90 out of the total of 100 pieces of MAE data are not less than the first determination criterion value and 100 out of the total of 100 pieces of MAPE data are not less than the second determination criterion value, then (90/100+100/100)/2=0.95 is the rate of criterion exceedance.

In the distribution calculation processing, the median of the MAE distribution, the median of the MAPE distribution, and the rate of criterion exceedance are calculated for all data (212 pieces of data in this example) included in the training data 31, and these calculation results are stored as distribution data 33 in the storage unit 3.

### Outlier Determination Processing Unit 24

The outlier determination processing unit 24 performs outlier determination processing to determine whether each data is an outlier based on the index values (the medians of the distributions in this example) of each data obtained in the distribution calculation processing. The outlier determination processing corresponds to the determining an outlier in the invention.

The outlier determination processing unit 24 determines that data with the index values (the medians of the distributions in this example) of not less than preset determination criterion values is an outlier. In more detail, the outlier determination processing unit 24 determines that data with the median of MAE (or ME, or RMSE) of not less than the preset first determination criterion value (e.g., 3 N/mm) as well as the median of MAPE (or MPE, or RMSPE) of not less than the preset second determination criterion value is an outlier. The number (No.) assigned to the data determined to be an outlier is stored as outlier candidate data 34 in the storage unit 3.

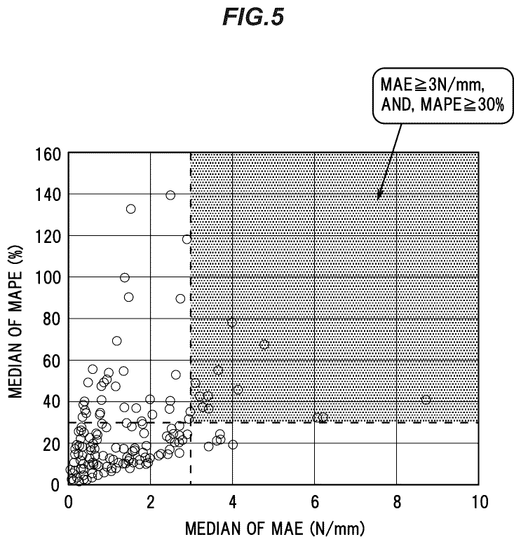

FIG. 5 is a diagram illustrating an example of distributions of the medians of MAE and MAPE obtained by the distribution calculation processing. When the first determination criterion value is 3 N/mm and the second determination criterion value is 30%, data plotted in the hatched area in FIG. 5 are determined to be outliers.

### Outlier Removal Processing Unit 25

The outlier removal processing unit 25 performs outlier removal processing to remove data determined to be an outlier in the outlier determination processing. The outlier removal processing corresponds to the removing an outlier in the invention.

The outlier removal processing unit 25 is configured to remove only one data when there are plural data determined to be outliers in the outlier determination processing. This is because some of data determined to be outliers may have a large prediction error due to the influence of other outliers, and it is to prevent data which are not outliers from being removed.

When there are plural data determined to be outliers in the outlier determination processing, the outlier removal processing unit 25 removes only data with the largest proportion of errors of more than the determination criterion value in the prediction error distribution. In more particular, the outlier removal processing unit 25 removes, among the data included in the outlier candidate data 34, only one data with the highest rate of criterion exceedance from the training data 31 (removes an outlier and updates the training data 31). As mentioned above, the rate of criterion exceedance is the average value of the percentage of MAE (or ME, or RMSE) of not less than the first determination criterion value and the percentage of MAPE (or MPE, or RMSPE) of not less than the second determination criterion value. The outlier removal processing unit 25 stores the data, which is removed as an outlier, as outlier data 35 in the storage unit 3. The rate of criterion exceedance may be set as the product of the percentage of errors of not less than the first determination criterion value and the percentage of errors of not less than the second determination criterion value.

The control unit 2 repeats the prediction error calculation processing, the outlier determination processing and the outlier removal processing until no more data is determined to be an outlier in the outlier determination processing. Then, when no more data is determined to be an outlier in the outlier determination processing, the control unit 2 ends the processing. The training data 31 with outliers removed can thereby be obtained.

### Outlier Removal Method

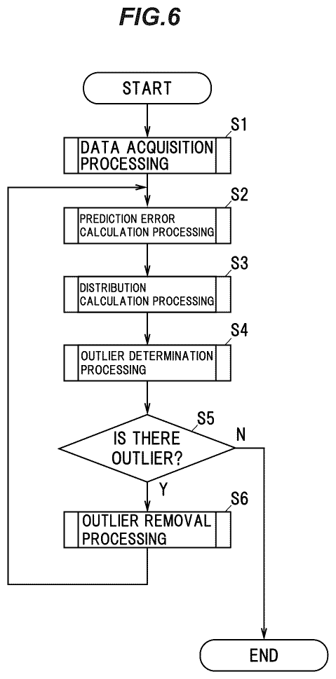

FIG. 6 is a flowchart showing an outlier removal method in the present embodiment. As shown in FIG. 6, first, the data acquisition processing unit 21 performs the data acquisition processing to acquire the training data 31 from an external device, etc. in Step S1. The acquired training data 31 is stored in the storage unit 3.

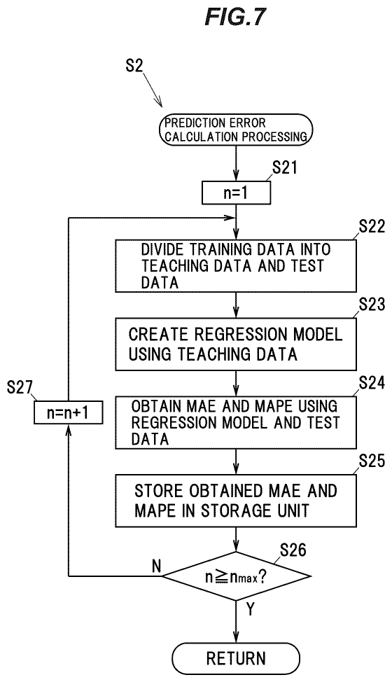

After that, the prediction error calculation processing is performed in Step S2. In the prediction error calculation processing, first, in Step S21, an initial value of 1 is assigned to a variable n representing the number of repetitions, as shown in FIG. 7. Also, a numerical value (955 in this example) is assigned to the variable nₘₐₓ representing the maximum number of repetitions. After that, in Step S22, the prediction error calculation processing unit 22 randomly divides the training data 31 into teaching data and test data. Then, in Step S23, the prediction error calculation processing unit 22 creates a regression model using the teaching data. After that, in Step S24, the prediction error calculation processing unit 22 applies the test data to the created regression model and obtains MAE and MAPE which are prediction errors. After that, in Step S25, the prediction error calculation processing unit 22 stores the obtained MAE and MAPE as the prediction error data 32 in the storage unit 3. After that, in Step S26, it is determined whether the variable n is not less than nₘₐₓ (955 in this example). When the determination made in Step S26 is NO (N), n is incremented in Step S27 and the process then returns to Step S22. When the determination made in Step S26 is YES (Y), the process returns and proceeds to Step S3 in FIG. 6.

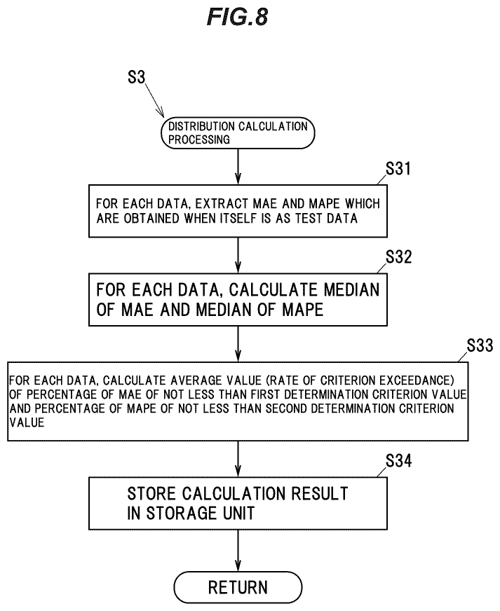

In Step S3, the distribution calculation processing is performed. In the distribution calculation processing, first, in Step S31, the distribution calculation processing unit 23 extracts, for each data included in the training data 31, MAE and MAPE when using that data as test data from the prediction error data 32, as shown FIG. 8. After that, in Step S32, the distribution calculation processing unit 23 calculates the median of the MAE distribution and the median of the MAPE distribution for each data. Then, in Step S33, the distribution calculation processing unit 23 calculates, for each data, an average value of the percentage of MAE of not less than the preset first determination criterion value and the percentage of MAPE of not less than the preset second determination criterion value, i.e., calculates the rate of criterion exceedance. After that, in Step S34, the distribution calculation processing unit 23 stores the medians of MAE and MAPE and the rate of criterion exceedance for each data, which are obtained by the calculations, as the distribution data 33 in the storage unit 3. After that, the process returns and proceeds to Step S4 in FIG. 6.

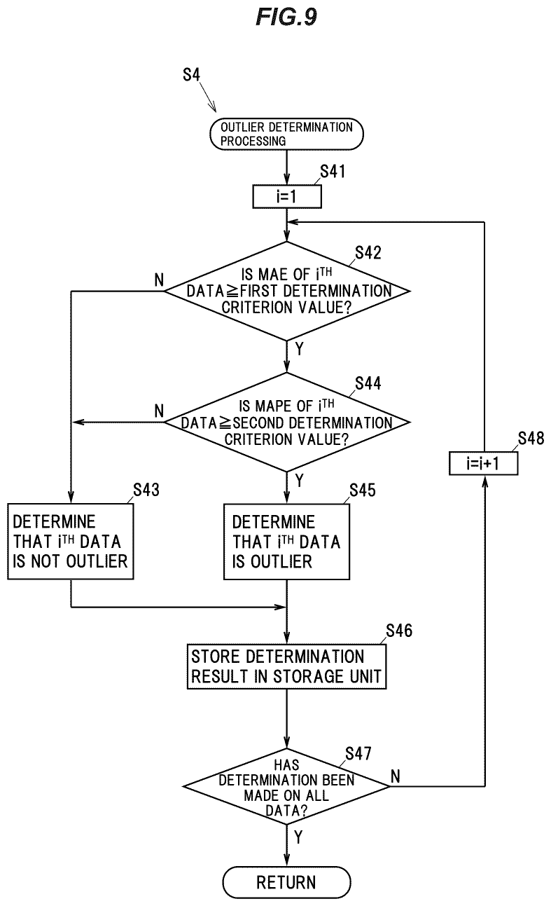

In Step S4, the outlier determination processing is performed. In the outlier determination processing, first, in Step S41, the outlier determination processing unit 24 assigns the initial value of 1 to a variable i indicating the data number, as shown in FIG. 9. After that, in Step S42, the outlier determination processing unit 24 determines whether the MAE of the i^{th} data is not less than the first determination criterion value.

When the determination made in Step S42 is NO, the outlier determination processing unit 24 determines that the i^{th} data is not an outlier in Step S43, and the process proceeds to Step S46. When the determination made in Step S42 is YES, the outlier determination processing unit 24 determines whether the MAPE of the i^{th} data is not less than the second determination criterion value in Step S44. When the determination made in Step S44 is NO, the outlier determination processing unit 24 determines that the i^{th} data is not an outlier in Step S43, and the process proceeds to Step S46. When the determination made in Step S44 is YES, the outlier determination processing unit 24 determines that the i^{th} data is an outlier in Step S45, and the process proceeds to Step S46.

In Step S46, the outlier determination processing unit 24 stores the results of the determinations made in Steps S43 and S45 in the storage unit 3. Here, the outlier determination processing unit 24 stores the number i, which is assigned to the data determined to be an outlier, as the outlier candidate data 34 in the storage unit 3. After that, in Step S47, the outlier determination processing unit 24 determines whether a determination has been made on all data. When the determination made in Step S47 is NO, the variable i is incremented in Step S48 and the process returns to Step S42. When the determination made in Step S47 is YES, the process returns and proceeds to Step S5 in FIG. 6.

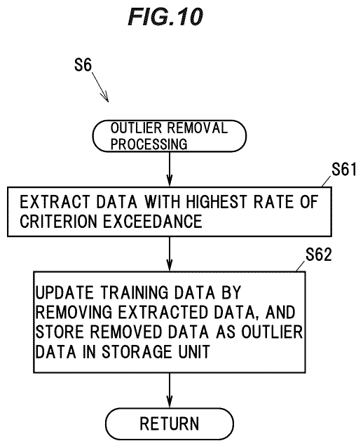

In Step S5, it is determined whether there is an outlier as a result of the determination in Step S4. When the determination made in Step S5 is NO, the process ends. When the determination made in Step S5 is YES, the outlier removal processing is performed in Step S6. In the outlier removal processing, in Step S61, the outlier removal processing unit 25 refers to the distribution data 33 and extracts data with the highest rate of criterion exceedance among the data included in the outlier candidate data 34, as shown in FIG. 10. After that, in Step S62, the outlier removal processing unit 25 updates the training data 31 by deleting the extracted data, and also stores the data, which is removed from the training data 31, as the outlier data 35 in the storage unit 3. After that, the process returns to Step S2 in FIG. 6.

Change in Prediction Accuracy Resulted from Outlier Removal

Changes in prediction accuracy when outliers are removed using the outlier removal method in the present embodiment were examined. A data set containing 212 pieces of data was used as the training data 31, where mixing amounts of 33 types of materials and material information of the quantified characteristics of the material constitution (e.g., the volume ratio of filler, etc.) were used as explanatory variables and tear strength was used as an objective variable.

Division of the training data 31, creation of a regression model using the teaching data obtained by the division, and measurement of prediction errors (MAE and MAPE) by applying the test data obtained by the division to the regression model were repeated 955 times, and for each data, about 300 prediction errors when using that data as test data were obtained. Then, the median of the MAE distribution, the median of the MAPE distribution, and the rate of criterion exceedance were respectively calculated from the prediction error distribution of each data, and data was determined to be an outlier when the median of the MAE distribution was not less than 3 N/mm as well as the median of the MAPE distribution was not less than 30%. The data with the highest rate of criterion exceedance among the data determined to be outliers was removed, and the processing was repeated until there was no more data determined to be an outlier. As a result, after removing 10 outliers, no data was determined to be an outlier.

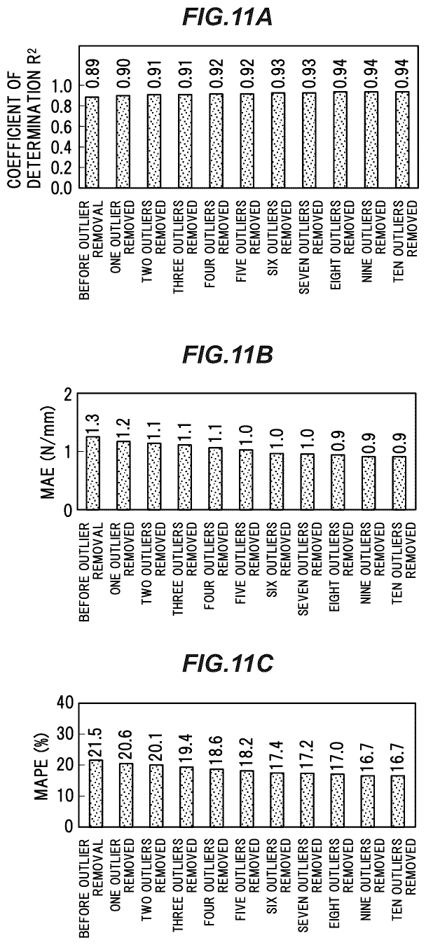

A coefficient of determination R², MAE, and MAPE were evaluated each time the outlier was removed. The results are shown in FIGS. 11A to 11C. As shown in FIG. 11A, the coefficient of determination R² increases with more outliers removed. In addition, as shown in FIGS. 11B and 11C, with more outliers removed, MAE and MAPE decrease and prediction accuracy is improved.

### Functions and Effects of the Embodiment

As described above, the outlier removal method in the present embodiment includes the step of calculating prediction errors by repeating, a predetermined number of times, division of the training data 31 into teaching data and test data, creation of a regression model representing a correlation between the explanatory variable and the objective variable using the teaching data, and calculation of a prediction error using the test data on the created regression model, the step of calculating a distribution by extracting, for each data included in the training data 31, prediction errors when using that data as the test data from prediction errors obtained in the step of calculating prediction errors, and obtaining, for each data included in the training data, an index value (the median in this example) characterizing a distribution of the extracted prediction errors, the step of determining an outlier by determining whether each data is an outlier based on the index value of each data obtained in the step of calculating a distribution, and the step of removing an outlier by removing data determined to be an outlier in the step of determining an outlier.

This makes it possible to properly remove outliers when outliers are included in the training data 31. As a result, the training data 31 from which outliers have been properly removed can be used for machine learning, and it is thereby possible to improve accuracy of prediction such as physical property prediction.

Data which have a large prediction error when applied to the regression model created with the teaching data divided from the training data 31 (i.e., data which does not provide good prediction with the created regression model) are removed as outliers in the present embodiment, but if, e.g., there is only one regression model for determining outliers, there may be data which is accidentally determined to be an outlier even though it is not an outlier. By using a method in which the training data 31 is divided plural times to create plural different regression models and the distribution of prediction errors when applying each data as test data is evaluated as in the present embodiment, it is possible to significantly reduce the possibility that data is accidentally determined as an outlier even though it is not an outlier as described above, and it is possible to properly remove outliers even when the training data 31 is sparse data.

### Modification

Although not mentioned in the above embodiment, the outlier removal device 1 may be incorporated as a function into a prediction device that predicts physical properties, etc. using the training data 31. In this case, the prediction device includes a regression model creation unit that performs machine learning using the training data 31 with outliers removed and creates a regression model representing a correlation between the explanatory variable and the objective variable, and a prediction unit that predicts physical properties, etc. using the regression model created by the regression model creation unit.

### Summary of Embodiment

Next, the technical concepts that can be grasped from the above embodiment will be described with the help of the codes, etc. in the embodiment. However, each sign, etc. in the following description is not limited to the members, etc. specifically shown in the embodiment for the constituent elements in the scope of claims.

According to the first feature, an outlier removal method is a method for removing an outlier included in training data 31 that comprises data of an explanatory variable and an objective variable used for machine learning, the method comprising: calculating prediction errors by repeating, a predetermined number of times, division of the training data 31 into teaching data and test data, creation of a regression model representing a correlation between the explanatory variable and the objective variable using the teaching data, and calculation of a prediction error using the test data on the created regression model; calculating a distribution by extracting, for each data included in the training data 31, prediction errors when using that data as the test data from prediction errors obtained in the calculating prediction errors, and obtaining, for each data included in the training data 31, an index value characterizing a distribution of the extracted prediction errors; determining an outlier by determining whether each data is an outlier based on the index value of each data obtained in the calculating a distribution; and removing an outlier by removing data determined to be an outlier in the determining an outlier.

According to the second feature, in the outlier removal method as described in the first feature, when a plurality of data are determined to be outliers in the determining an outlier, only one data thereamong is removed in the removing an outlier, and the calculating prediction errors, the determining an outlier and the removing an outlier are repeated until no more data is determined to be an outlier in the determining an outlier.

According to the third feature, in the outlier removal method as described in the second feature, data with the index value of not less than a preset determination criterion value is determined to be an outlier in the determining an outlier, and when a plurality of data are determined to be outliers in the determining an outlier, only data having the distribution of the prediction errors in which the proportion of errors of more than the determination criterion value is largest is removed in the removing an outlier.

According to the fourth feature, in the outlier removal method as described in the any one of the first to third features, the index value is a median of the distribution of the prediction errors.

According to the fifth feature, in the outlier removal method as described in the any one of the first to fourth features, at least one of mean error (ME), mean absolute error (MAE) and root mean square error (RMSE) and one of mean percentage error (MPE), mean absolute percentage error (MAPE) and root mean square percentage error (RMSPE) are used as the prediction error, and data, in which the index value of any one of the mean error (ME), the mean absolute error (MAE) and the root mean square error (RMSE) is not less than a preset first criterion value and also the index value of any one of the mean percentage error (MPE), the mean absolute percentage error (MAPE) and the root mean square percentage error (RMSPE) is not less than a preset second criterion value, is determined to be an outlier in the determining an outlier.

According to the sixth feature, an outlier removal device 1 that removes an outlier included in training data 31 that comprises data of an explanatory variable and an objective variable used for machine learning, the device comprising: a prediction error calculation processing unit 22 that repeats, a predetermined number of times, division of the training data 31 into teaching data and test data, creation of a regression model representing a correlation between the explanatory variable and the objective variable using the teaching data, and calculation of a prediction error using the test data on the created regression model; a distribution calculation processing unit 23 that extracts, for each data included in the training data 31, prediction errors when using that data as the test data from prediction errors obtained by the prediction error calculation processing unit 22, and obtains, for each data included in the training data 31, an index value characterizing a distribution of the extracted prediction errors; an outlier determination processing unit 24 that determines whether each data is an outlier based on the index value of each data obtained by the distribution calculation processing unit 23; and an outlier removal processing unit 25 that removes data determined to be an outlier by the outlier determination processing unit 24.

The above description of the embodiment of the invention does not limit the invention as claimed above. It should also be noted that not all of the combinations of features described in the embodiment are essential to the means for solving the problems of the invention. In addition, the invention can be implemented with appropriate modifications to the extent that it does not depart from the gist of the invention.

1. An outlier removal method for removing an outlier included in training data that comprises data of an explanatory variable and an objective variable used for machine learning, the method comprising:
calculating prediction errors by repeating, a predetermined number of times, division of the training data into teaching data and test data, creation of a regression model representing a correlation between the explanatory variable and the objective variable using the teaching data, and calculation of a prediction error using the test data on the created regression model;
calculating a distribution by extracting, for each data included in the training data, prediction errors when using that data as the test data from prediction errors obtained in the calculating prediction errors, and obtaining, for each data included in the training data, an index value characterizing a distribution of the extracted prediction errors;
determining an outlier by determining whether each data is an outlier based on the index value of each data obtained in the calculating a distribution; and
removing an outlier by removing data determined to be an outlier in the determining an outlier.

2. The method according to claim 1, wherein when a plurality of data are determined to be outliers in the determining an outlier, only one data thereamong is removed in the removing an outlier, and the calculating prediction errors, the determining an outlier and the removing an outlier are repeated until no more data is determined to be an outlier in the determining an outlier.

3. The method according to claim 2, wherein data with the index value of not less than a preset determination criterion value is determined to be an outlier in the determining an outlier, and wherein when a plurality of data are determined to be outliers in the determining an outlier, only data having the distribution of the prediction errors in which the proportion of errors of more than the determination criterion value is largest is removed in the removing an outlier.

4. The method according to claim 1, wherein the index value is a median of the distribution of the prediction errors.

5. The method according to claim 1, wherein at least one of mean error (ME), mean absolute error (MAE) and root mean square error (RMSE) and one of mean percentage error (MPE), mean absolute percentage error (MAPE) and root mean square percentage error (RMSPE) are used as the prediction error, and wherein data, in which the index value of any one of the mean error (ME), the mean absolute error (MAE) and the root mean square error (RMSE) is not less than a preset first criterion value and also the index value of any one of the mean percentage error (MPE), the mean absolute percentage error (MAPE) and the root mean square percentage error (RMSPE) is not less than a preset second criterion value, is determined to be an outlier in the determining an outlier.

6. An outlier removal device that removes an outlier included in training data that comprises data of an explanatory variable and an objective variable used for machine learning, the device comprising:
a prediction error calculation processing unit that repeats, a predetermined number of times, division of the training data into teaching data and test data, creation of a regression model representing a correlation between the explanatory variable and the objective variable using the teaching data, and calculation of a prediction error using the test data on the created regression model;
a distribution calculation processing unit that extracts, for each data included in the training data, prediction errors when using that data as the test data from prediction errors obtained by the prediction error calculation processing unit, and obtains, for each data included in the training data, an index value characterizing a distribution of the extracted prediction errors; an outlier determination processing unit that determines whether each data is an outlier based on the index value of each data obtained by the distribution calculation processing unit; and
an outlier removal processing unit that removes data determined to be an outlier by the outlier determination processing unit.
